(19) United States
(12) Patent Application Publication
(10) Pub. No.: US 2010/0247915 A1
(43) Pub. Date: Sep. 30, 2010

(54) PARTICLE COMPRISING CORE AND SHELL

(75) Inventors: Yukiko Furukawa, Enschede (NL); Wilhelmus C. Keur, Weert (NL); Harrie Van Hal, Vessem (NL); Cornelis A. H. A. Mutsaers, Veldhoven (NL)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP B.V., Eindhoven (NL)

(21) Appl. No.: 12/738,134

(22) PCT Filed: Oct. 13, 2008
(86) PCT No.: PCT/IB08/54207

§ 371 Date: Apr. 15, 2010

(30) Foreign Application Priority Data
Oct. 16, 2007 (EP) 07118565.6

(51) Int. Cl. B32B 15/00; B05D 3/04

(52) U.S. Cl. 428/403; 427/377; 977/773

(57) ABSTRACT

The present invention relates to particles comprising a core and a shell, and a method of producing said particle. The core comprises mainly TiN, wherein the shell comprises mainly TiO2. The shell has a thickness of more than 5 nm and of less than 200 nm. The core size is preferably larger than 10 nm and is preferably smaller than 100 um.

### FIELD OF THE INVENTION

The present invention relates to particles comprising a core and a shell, a method of producing said particle, various uses of said particle as well as various products comprising said particle.

### BACKGROUND OF THE INVENTION

Particles comprising a core and a shell are known.

It is noted that the anatase phase is not the most stable phase for TiO₂. The rutile phase is the most common natural form in TiO₂. It is therefore a problem to prepare the in many aspects more desired anatase phase, and further to maintain the anatase phase over a longer period of time.

CN1792445 discloses a nanoclass semiconductor-type composite catalyst of a semiconductor nanoparticle consisting of the sulfide or selenide as core and the coated TiO₂ layer as shell. Its preparing process includes such steps as preparing high-dispersity cadmium sulfide (or selenide) nanoparticles by a wet chemical method and surfactant modifying, ultrasonic hydrolysis of the organic alkoxide of Ti to obtain TiO₂, and physical combination between TiO₂ and cadmium sulfide (or selenide) nanoparticles. It has a high photocatalytic activity and stability.

This document is silent on particle sizes.

US2004/245496 A1 discloses a novel cleaning agent comprising at least one member of the group consisting of TiOₓ (1.5<x<2), TiOₓN₂₋ₓ (1<x<2), diamond-like carbon, and a titania-silica complex TiOₓ—SiO₂ (1.5<x<=2), and a method for cleaning objects with said cleaning agent. The invention further provides an antibacterial material containing the above-mentioned materials, an antibacterial product featuring the same, a method for manufacturing an environmental material, a novel functional adsorbent, and a method for manufacturing the same.

The particle sizes are, however, typically much smaller than 100 nm. Furthermore, the relative amount of TiOₓ is much higher than in the present invention, and the particles do not comprise a core and a shell.

It is at present, however, very difficult or impossible to manufacture small particles, i.e. wherein the core size is preferably larger than 10 nm and preferably smaller than 100 μm, which are stable, e.g. do not alter over time spontaneously, do not undergo a phase transition, are stable in the environment of use, etc.

Further, it is very difficult or impossible to manufacture particles which are more or less uniform with respect to core size and shell thickness, specifically wherein the shell thickness is relatively small. Whenever shell thicknesses become relatively small, the shell typically tends to have open spacings within the shell. Also, such a shell typically contains areas, that, upon chemical treatment, undergo no treatment, i.e. remain as before the treatment, and areas which are preferably treated, i.e. have a much larger thickness than the average thickness of the shell, thus have thicker and thinner layer thicknesses, instead of the ideally expected homogeneous layer thickness.

It is noted that simply oxidizing TiN particles would result in TiO₂ particles, leaving no TiN. The reaction conditions are therefore critical for obtaining particles comprising a core and a shell.

Typically, methods available are quite expensive.

It is therefore the aim of the present invention to solve one or more of the above-mentioned problems.

Surprisingly, the present invention provides solutions to the above-mentioned problems. Furthermore, where applicable, it improves the performance of core-shell particles in one or more aspects. It also makes applications possible, which have not been possible up to now, or at the most in a limited form.

It is believed that one of the main characteristics of this application is the effect the thickness of the shell of the particles has on the appearance thereof. If the shell thereof becomes too thick, the color of the particles changes from black to for instance yellow. As a consequence, the absorption of light is limited, for instance because not all or most of the wavelength present therein can be absorbed. Thus, such particles become less efficient in terms of energy conversion. If the shell thickness becomes to small, gaps within the shell start to appear, and as a consequence no (visible) light will be absorbed in such gaps. By varying the thickness of the shell the specific absorption range, in terms of wavelength/energy, can be tailored. So, nanoparticles with different diameters and different shell thickness can be used to broaden the absorption spectra and thus enhance the energy conversion efficiency.

### SUMMARY OF THE INVENTION

In a first aspect the invention discloses a particle, wherein the core comprises mainly TiN, wherein the shell comprises mainly TiO₂, which shell has a thickness of more than 5 nm, preferably more than 20 nm, more preferably more than 50 nm, and wherein the shell has a thickness of less than 200 nm, wherein the core size is preferably larger than 10 nm, more preferably larger than 50 nm, even more preferably larger than 100 nm, even more preferably larger than 500 nm, most preferably larger than 1000 nm, and wherein the core size is preferably smaller than 100 μm, more preferably smaller than 50 μm, even more preferably smaller than 25 μm, even more preferably smaller than 10 μm, most preferably smaller than 3 μm.

The terms “core” and “shell” refer to the geometry of the particle. The term “core size” refers to the diameter of a more or less sphere like particle, which size can be measured by e.g. light-scattering techniques, TEM etc. The thickness of the shell can be measured by e.g. TEM. Core and shell can be further identified by e.g. the chemical composition thereof.

The particle according to the invention may be used in a layer, coating, device, or composition.

The particle according to the invention surprisingly has a core size larger than 10 nm and smaller than 100 μm, which are stable, which are more or less uniform with respect to core size and shell thickness, with a shell thickness that is relatively small, virtually without open spacings within the shell, with a uniformly formed shell.

The inventors believe, without wishing to be bound by theory, that the thickness of the shell is bound by strict limits, e.g. due to a desired presence of surface plasmons and/or quantum confinement. If the thickness of the shell is too small or too thick, the effect is lost. Typically in these cases the shell may have a thickness of 5 nm-200 nm, such as 10 nm, or 20 nm, or 100 nm. Furthermore, the momentum conservation must be fulfilled.

Roughening or patterning of the surface with typical dimensions of the pattern or the surface roughness in the order of the wavelength of the electromagnetic wave can achieve this. Or by using nanoparticles with diameters ranging from several 10th of nanometer (like 20 nm) up to several 100th of nanometers (like 200 nm). Alternatively, larger particles can also be used if they exhibit sharp corners or surface roughness with a typical dimension in the order of the wavelength. In these cases the momentum conservation is fulfilled. The resonance frequency depends partly on the diameter of the nanoparticle as well as the shape change the surface plasmon resonance due to confinement effects. So nanoparticles with different diameters can be used to broaden the absorption spectra and thus enhance the energy conversion efficiency.

With the term “mainly” it is meant, that apart from unavoidable impurities, the Ti compound is present in a pure form, e.g. comprising more than 90% of Ti compound, preferably comprising more than 95% of Ti compound, more preferably comprising more than 99% of Ti compound, even more preferably comprising more than 99.9% of Ti compound, most preferably comprising more than 99.99% of Ti compound. The Ti compound typically comprises one other element, typically an anion type, but may comprise a mixture of other elements.

In a preferred embodiment the variation in relative thickness of the shell is less than ±20%, preferably less ±10%, more preferably less ±5%, which further improvement is established by optimizing process conditions. Thus, for particles varying in size, such as for instance from 300 nm-1500 nm, a shell thickness of for instance 30 nm±5 nm for all particles is obtained. These facts have been established by TEM and EDS measurements.

In a preferred embodiment the particle according to the invention has a shell, which comprises mainly TiO₂, and a core, which comprises mainly TiN.

In a preferred embodiment the particle according to the invention has a core, which comprises 0.1-99.9999% of the volume and a shell which comprises 99.9-0.0001% of the volume.

Typically particles according to the invention will comprise 4-90% TiN and 96-10% TiO₂, such as 96% TiO₂, 75% TiO₂, 50% TiO₂, 25% TiO₂, 16% TiO₂, and 10% TiO₂.

As such, particles can be tailored to specific requirements for intended uses, and thus optimized for said uses. Preferably the TiO₂ comprises primarily the anatase phase, such as more than 60%, preferably more than 75%, more preferably more than 85%, such as 90% or 95% or more, whereas the remainder of the TiO₂ is preferably in the rutile phase. As can be seen from the experiments the amount of anatase present, as determined by measurements, can be used to identify an optimal oxidizing temperature. Preferably the amount of anatase is maximized.

In a second aspect the invention discloses a method of manufacturing a particle according to the invention, comprising the steps of:

i) providing a core,

ii) forming a shell around the core by heating in an oxidizing atmosphere.

The reaction conditions, such as temperature, amount of active chemical species, such as those containing O, duration, are quite critical. The reaction rate should not be too fast, as otherwise the core is fully converted to the second Ti compound. One of the reasons is that the reaction is typically exothermic, causing an acceleration of the reaction.

Thus, the reaction rate should be controlled by limiting one or more of the amount of heat formed, the relative amount of reactive species present, the relative amount of raw (only core material) particles, the physical characteristics of the reaction, such as reaction tube, fluidized bed, etc., the packing density of the powder, the temperature, the duration etc. Preferably the initial reaction rate should be smaller than 30 nm/min., as measured by the thickness of the shell formed over time, more preferably less than 15 nm/min, and even more preferably less than 5 nm/min.

In a preferred embodiment the method according to the invention comprises a step ii) which is performed for more than 15 min. to a temperature of more than 400° C., in an atmosphere comprising an oxidizing agent, such as O₂, thereby forming TiO₂.

Preferably the atmosphere comprises >0.1% O₂, more preferably >1% O₂, even more preferably >2% O₂, most preferably >4% O₂, and comprises <100% O₂, more preferably <50% O₂, even more preferably <20% O₂, most preferably <6% O₂. The atmosphere may further comprise inert gases, such as N₂, non-reactive species, etc. The amount of O2 will, as is explained above, depend on other reaction conditions.

The oxidizing atmosphere may also comprise other oxidizing species, comprising O, such as ozone, peroxide, water vapor etc.

Preferably the TiN particle is heated to a temperature of from 400° C.-800° C., more preferably from 450° C.-600° C., even more preferably from 500° C.-550° C. At these temperatures the best results with respect to shell uniformity are obtained.

Preferably the TiN particle is heated for more than 5 min., more preferably for more than 15 min., more preferably for more than 60 min., and is heated for less than 240 min., more preferably for less than 180 min., more preferably for less than 120 min.

It is noted that in order to obtain optimal effects the particles should not be too large, as the ratio between effective area and volume will decrease. Particles should also not be too small. Clearly the actual size of the particles may be adapted to the use envisaged. The size of the particles, as well as the ratio between the thickness of core and shell, may be optimized for each use or purpose.

Advantages of the present particles are the ease of use, the low processing costs involved, the homogeneity of the shell layer, their characteristics that can be tailored in a relatively broad scope, their relative non-toxicity and environmental friendliness.

The homogeneity of the present particles is more or less uniform with respect to core size and shell thickness, specifically wherein the shell thickness is relatively small. Whenever shell thickness become relatively small, the shell typically does not tend to have open spacings within the shell. Also, such a shell typically does not contain areas that, upon chemical treatment, undergo no treatment, i.e. remain as before the treatment, and areas which are preferably treated, i.e. have a much larger thickness than the average thickness of the shell. Thus the present particles have the ideally expected homogeneous layer thickness.

Amongst others, this is important for the plasmon effect, as well as for a controlled performance of the particles, e.g. in terms of physical and chemical characteristics.

It is also important that, where relevant or required, the desired phase of the shell is formed. For instance, in the case of TiO₂ the anatase phase is the most effective phase in terms of energy conversion. However, the present particles may also have a mixed phase of mainly anatase and the remainder of rutile, which mixed phase is even more effective in terms of energy conversion.

The present particles may be optimized for each use or purpose, by tailoring the size of the particles, as well as the ratio between the thickness of core and shell. This tailoring requires a well-controlled process, which process was up till now not available.

As an example of characteristics that may be tailored, the specific absorbance at a certain wavelength, and thus also their activity, can be changed by altering the relative amount of shell (see below).

Typical embodiments, uses thereof, and advantages obtained thereby will become clear form the following description and examples.

The following examples are intended to illustrate the various aspects of the present invention. The examples are not meant to limit the invention in any way.

Further, is may be clear to the person skilled in the art that various combinations of the embodiments are also envisaged and also fall within the scope of the present invention.

### BRIEF DESCRIPTION OF THE DRAWINGS

FIG. 1 shows an schematic diagram of the oxidation.

FIG. 2 shows an XRD diffraction pattern for TiN powder.

FIG. 3 shows TEM and EDS results of the oxidized TiN powder.

FIG. 4 shows crystal structures for oxidized TiN powder.

FIG. 5 shows crystal structures for oxidized TiN powder.

FIG. 6 shows an amount of TiO₂ vs. O₂ in mixture of O₂ and N₂ gasses

FIG. 7 shows an amount of TiO₂ vs. amount of raw TiN powder.

### DETAILED DESCRIPTION OF THE DRAWINGS

### Examples

### Example 1

### Oxidation of TiN

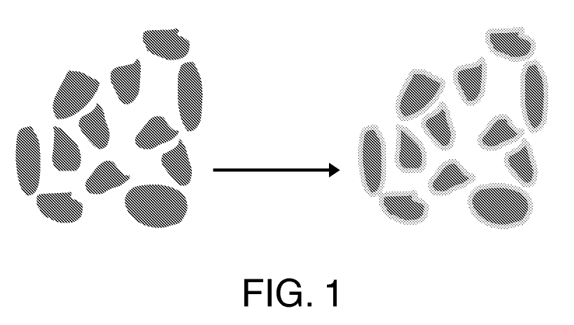

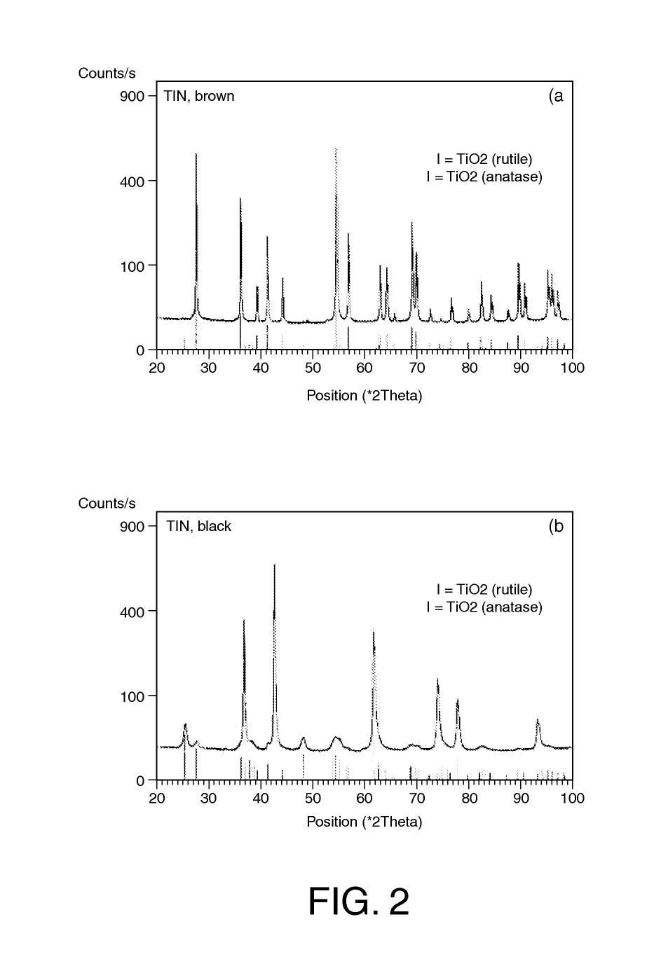

TiN powder was heat-treated at 400-600° C. for 1 hr in O₂. Both 1.45 g and 0.25 g of TiN powder began to be oxidized at 500° C. At 600° C. TiN powder was oxidized completely and the anatase phase present was converted to the rutile phase. In this case, 500° C. was the optimum temperature in the range mentioned to obtain the maximum amount of anatase. FIG. 1 shows the effect of O₂(%) in a mixed gas on the crystal structure of the oxidized TiN powder. Anatase was mainly formed at 4-19% of O₂ for 0.25 g TiN powder and 2-6% O₂ for 1.45 g TiN powder. According to FIGS. 1 and 2, the samples with about 20 wt % (e.g. 15-25 wt %) of TiO₂ had anatase as a main phase on the surface of TiN powder.

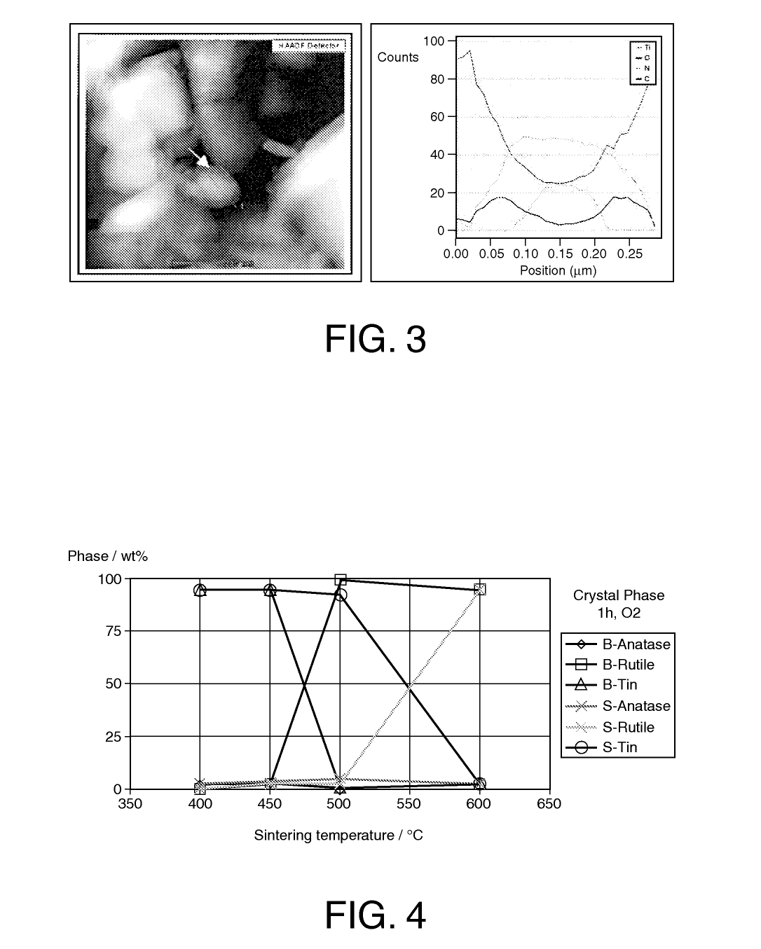

FIG. 3 shows the effect of the amount of TiN powder on the amount of the TiO₂ formed. The TiN powder was heated at 500° C. for 1 hr in 2 different atmospheres. 5% O₂ in a mixed gas gave approximately 20 wt % oxide for 0.25, 1.45, 10.0 and 21.0 g TiN, respectively, as a raw powder. The heat treatment at 500° C. for 1 hr in this ambient provided a large amount of anatase on TiN core.

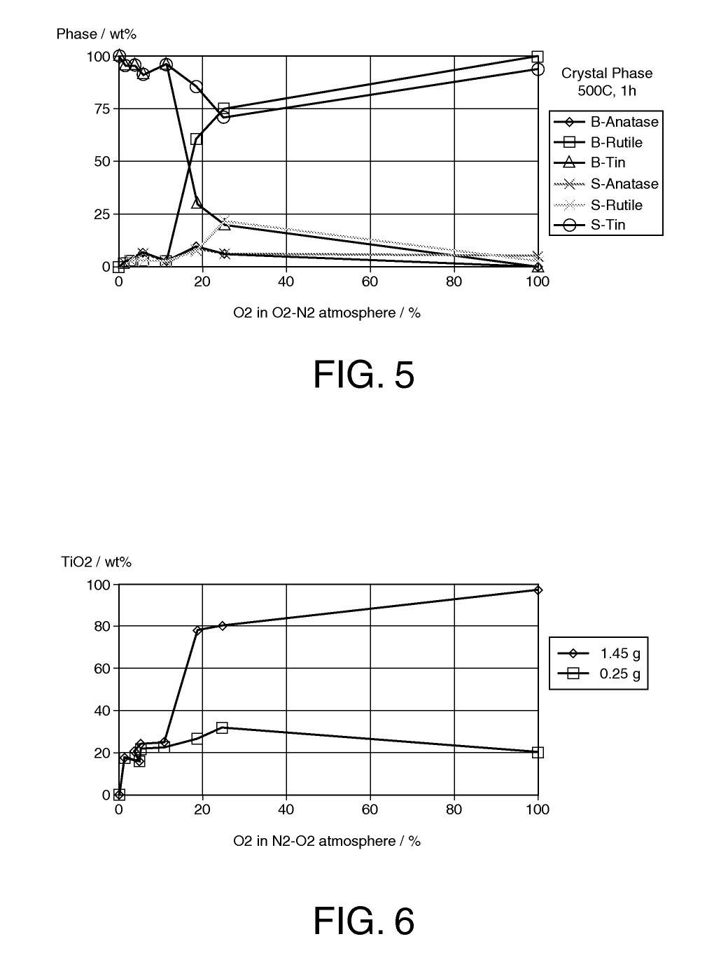

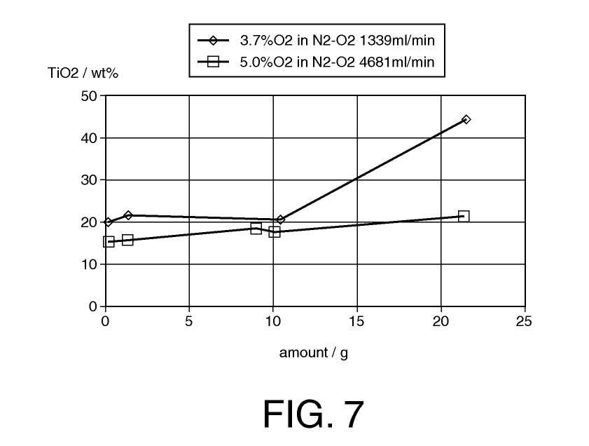

According to the XRD pattern (FIG. 4) the oxidation depends on the amount of the TiN powder, i.e. how the TiN powder was mounted in a container, such as the height of the packed powder and the packing density of the powder. This is due to the fact that the oxidation is an exothermic reaction. If 1.45 g of the TiN powder was oxidized at 500° C. in an O₂ atmosphere for 1 hr, the powder was completely oxidized and rutile was the main phase. While if 0.25 g of the TiN powder was oxidized under the same conditions, a TiN core and a TiO₂ shell was formed, wherein anatase was the main phase (FIG. 5).

This oxidation also depends on temperature and atmosphere during the heat treatment, thus several experiments have been carried out to find preferable conditions, under which anatase is mainly formed. FIG. 6 shows the crystal structure for the oxidized TiN powder.

1. A nano-particle comprising:
a core of a size comprising TiN;
a shell of a thickness comprising TiO₂; and
wherein the shell thickness is less than or equal to the core size.

2. Particle according to claim 1, wherein the variation in thickness of the shell is less than ±20%, preferably less ±10%, more preferably less ±5%.

3. Particle according to claim 1, wherein the core comprises 0.1-99.9999% of the volume and a shell comprises 99.9-0.0001% of the volume.

4. Method of manufacturing a particle according to claim 1, comprising the steps of:
i) providing a core,
ii) forming a shell around the core by heating in an oxidizing atmosphere.

5. Method according to claim 4, wherein step ii) is performed for more than 15 min., to a temperature of more than 400° C., in an atmosphere comprising an oxidizing agent, such as O₂.

6. Particle obtainable by the method according to claim 4.

7. Layer, coating, device, or composition, comprising a particle according to claim 1.

8. The nano-particle as recited in claim 1,
wherein the shell thickness is in the range of about 5 nm to about 200 nm; and
wherein the core size is in the range of about 10 nm to about 100 μm.

9. The nano-particle, as recited in claim 8,
wherein the shell thickness is in the range of about 20 nm to about 200 nm; and
wherein the core size is in the range of about 50 nm to about 50 μm.

10. The nano-particle as recited in claim 9,
wherein the shell thickness is in the range of about 50 nm to about 200 nm; and
wherein the core size is in the range of about 100 nm to about 25 μm.

11. The nano-particle as recited in claim 10,
wherein the shell thickness is in the range of about 50 nm to about 200 nm; and
wherein the core size is in the range of about 500 nm to about 10 μm.

12. The nano-particle as recited in claim 11,
wherein the shell thickness is in the range of about 50 nm to about 200 nm; and
wherein the core size is in the range of about 1000 nm to about 3 μm.
